(19) United States
(12) Patent Application Publication
(10) Pub. No.: US 2002/0075454 A1
(43) Pub. Date: Jun. 20, 2002

(54) Optical path design of a reflecting liquid crystal projector

(76) Inventor: Lin Chi Hsiung, Panchiao (TW)

Correspondence Address: J.C. Patents, Inc., 4 Venture, Suite 250, Irvine, CA, 92618, US

(21) Appl. No.: 09/790,795

(22) Filed: Feb. 22, 2001

(30) Foreign Application Priority Data
Dec. 15, 2000 (TW) 89126855

(51) Int. Cl. G03B 21/14

(52) U.S. Cl. 353/31

(57) ABSTRACT

An optical path of a reflecting liquid crystal projector is having an incidence light and three dichroic cubes. A first dichroic cube has a first coating with a normal vector of (1,0,1). The first dichroic cube can split the incidence light into two directions, one direction that reflects the blue light and red light and another direction that transmits the green light. A second dichroic cube has a second coating with a normal vector of (1,1,0). In the second dichroic cube, the red light is reflected to a red liquid crystal display (LCD) panel, and the blue light is transmitted to a blue LCD panel. A third dichroic cube has a third coating with a normal vector of (1,0,1). In the third dichroic cube, the green light is transmitted to a green LCD panel.

### CROSS-REFERENCE TO RELATED APPLICATION

This application claims the priority benefit of Taiwan application serial no. 89126855, filed Dec. 15, 2000.

### BACKGROUND OF THE INVENTION

1. Field of Invention

The present invention relates to a projection device of a reflecting liquid crystal projector. More particularly, the present invention relates to an optical path of a projection device of a reflecting liquid crystal projector.

2. Description of Related Art

In recent years, liquid crystal display (LCD) devices are gradually becoming common items in daily life, such as liquid crystal televisions, portable computers and liquid crystal projectors, etc. There are two types of light splitters in a conventional reflecting liquid crystal projector, including an off axial type and an on line type. In the off axial type, an incidence light and a outgoing light do not travel along in the same path. However, in the on line type, both the incidence light and outgoing light travel along the same path.

Referring to FIG. 1, the diagram illustrates an optical path of a reflecting off axial liquid crystal projector. The light source is an incidence light 100. The incidence light 100 polarizes a S-type polarization. Then the S-type polarization light is reflected from a polarization beam splitter (PBS) to a dichroic cube 102, which splits the light. The light projects to a reflecting LCD panel 104. A corresponding P-type polarization is reflected from the reflecting LCD panel 104 through a color recombiner 106 that recombines the lights together, forming a light. Then the light transmits through a projecting lens 108, and the image is projected on a screen.

In the above, the dichroic cube 102 splits the light and the color recombiner 106 recombines the light. The steps of splitting and recombining the light are two independent steps. Therefore this method can form an image with higher resolution. Although the techniques of the off axial type reflecting liquid crystal projector are improving, there are still many disadvantages to the off axial type projector. For example, because the optical paths are not the same path, it is difficult to adjust and focus the image on the optical path. Also, the off axial type reflecting liquid crystal projector is not easily manufactured, and the manufacturing cost is very high. The height of the projector is very high (approximately 6 inches). Moreover, the lens is not made easily, and the components are very large.

FIG. 2 illustrates an optical path of a Philips prism. After a light source 200 polarizes from the polarization beam splitter (PBS), an incidence source 200 of the Stype polarization is reflected into the color splitter/recombiner component.

The color splitter/recombiner component is made up of three dichroic cubes of prism, including a dichroic cube 202, a dichroic cube 204 and a dichroic cube 206. A first coating 208 is located between the dichroic cube 202 and the dichroic cube 204, and a second coating 210 is located between the dichroic cube 204 and dichroic cube 206. Red light and green light transmit through the first coating 208, but blue light is completely reflected. Green light transmits through the second coating 210, but red light is completely reflected.

Referring to FIG. 2, the incidence light 200 enters the dichroic cube 202, and the red light and green light of the incidence light 200 transmit through the first coating 208 into the dichroic cube 204. The blue light is reflected from the first coating 208 to the blue LCD panel 212. After the red light and green light transmit through the first coating 208 into the dichroic cube 204, the green light is transmitted through the second coating 210 to the green LCD panel 214. The red light is reflected from the second coating 210 to the red LCD panel 216.

Referring to FIG. 3, a color recombiner component is shown. The blue LCD panel 212, the green LCD panel 214 and the red LCD panel 216 respectively reflect blue light, green light and red light of P-type polarization. These three color lights travel along the original light trace, reflect to the color splitter and transmit through the PBS 218 into the projection lens 220. Finally the lights project an image onto the screen.

Referring to FIG. 4, the diagram illustrates the optical path of a color corner. A light source 300 transmits through a polarization beam splitter (PBS). The S-type polarization of the incidence light 300 is reflected into the color splitter/recombiner component of the color corner.

Referring to the color splitter component of the color corner, the color splitter/recombiner component is made up of three square-shaped dichroic cubes, including dichroic cubes 302, 304 and 306. The dichroic cube 302 reflects red and blue light but transmits green light. The dichroic cube 304 transmits red light but reflects blue light. The three primary color lights, green, red and blue light, respectively split into the green LCD panel 308, the red LCD panel 310 and the blue LCD panel 312. The color recombiner component recombines the lights. The green LCD panel 308, the red LCD panel 310 and the blue LCD panel 312 respectively reflect green, red and blue light of P-type polarization out from the splitter/recombiner component.

In the above described, the optical path of the liquid crystal projector does not have the same disadvantages as the off axial type, but the design of the splitter cannot reduce the size of the projector.

Splitter components in the current market, including the Philips prism, color corner or color link, are all designed as two-dimensional splitter components; that is, the incidence light and outgoing light both travel in the same plane. The projecting lens moves up and stays in a fixed position when the liquid crystal projector is off-set. Thus, both the Philips prism and color corner have an empty space over the splitter/recombiner component. This empty space is not satisfactorily used and does not support the current trend of fabricating a lighter, thinner, shorter and smaller projector.

### SUMMARY OF THE INVENTION

The invention provides a three-dimensional splitter/recombiner component to reduce the size of the projector. In the cubic type design, the incidence light and outgoing light do not travel in the same plane, and the empty space over the splitter/recombiner component can be used more efficiently, thus reducing the size of the projector.

As embodied and broadly described herein, the invention provides an optical path of a reflecting liquid crystal projector. The projector includes a light source, a polarization beam splitter (PBS), and a set of dichroic cubes. Firstly, the S-type polarization of the light source is reflected from the PBS to a set of dichroic cubes. The set of the dichroic cubes includes a first dichroic cube, a second dichroic cube and a third dichroic cube. The first dichroic cube includes a first coating with a normal vector of (1,0,1). The first coating splits the light source into two directions: the red light and the blue light reflect from the coating and the green light transmits through the coating. The second dichroic cube is installed on one side of the first dichroic cube, the side where the red light and blue light are reflected from the first coating. The second dichroic cube includes a second coating with a normal vector of (1,1,0). Red light of the incidence light is reflected to a red liquid crystal display (LCD) panel, and blue light is reflected to a blue LCD panel. The third dichroic cube is installed over the first dichroic cube in the transmission path of the green light. The third dichroic cube includes a third coating with a normal vector of (1,0,1). Green light is transmitted into a green LCD panel.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a diagram of an optical path of a conventional off axial liquid crystal projector;

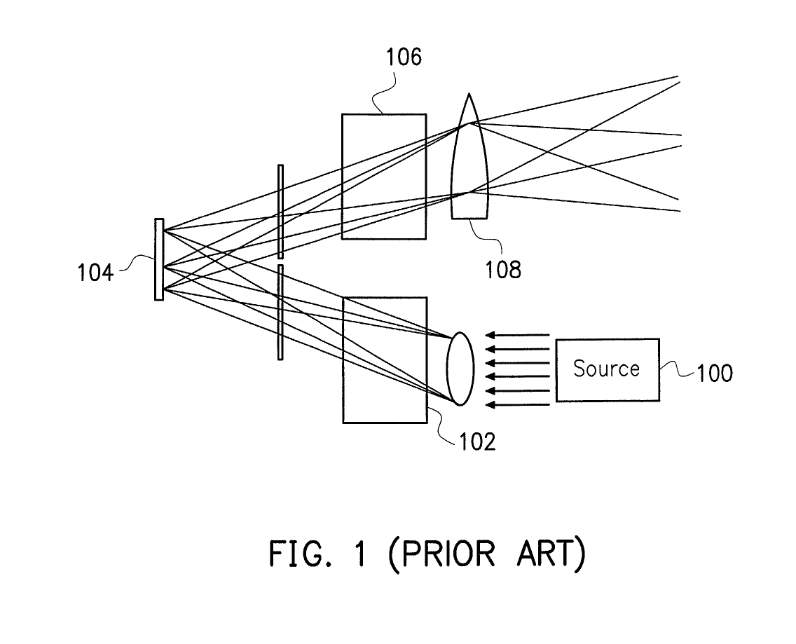

FIG. 2 is a diagram of an optical path of the Philips prism;

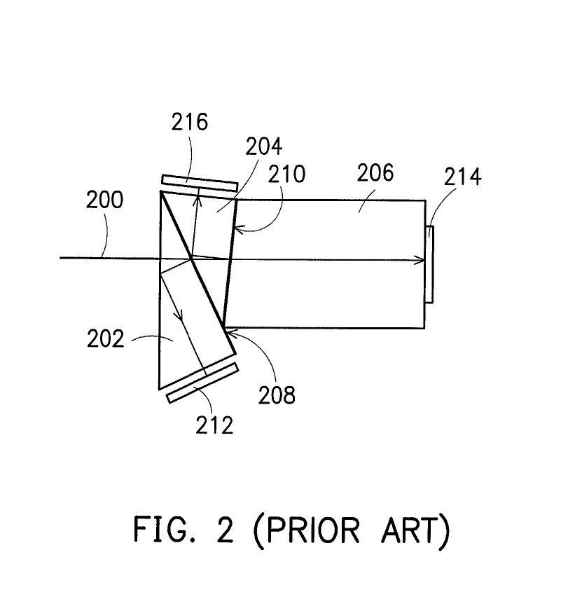

FIG. 3 is a diagram of an optical path of the Philips prism combined with the projecting lens and polarization beam splitter (PBS);

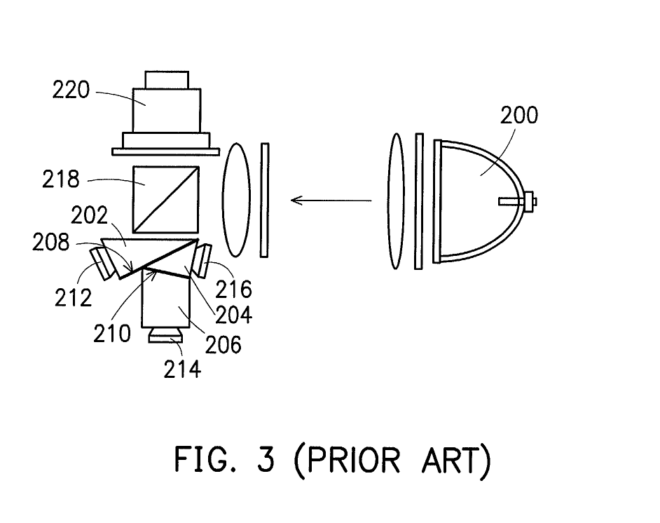

FIG. 4 is a diagram of an optical path of the color corner; and

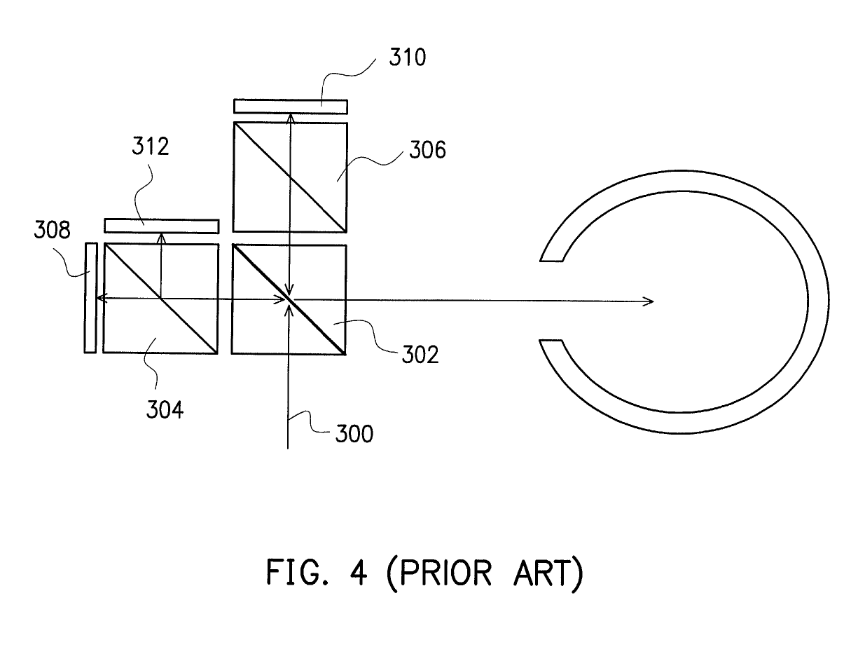

FIG. 5 is a diagram of an optical path design according to one preferred embodiment of this invention.

### DESCRIPTION OF THE PREFERRED EMBODIMENTS

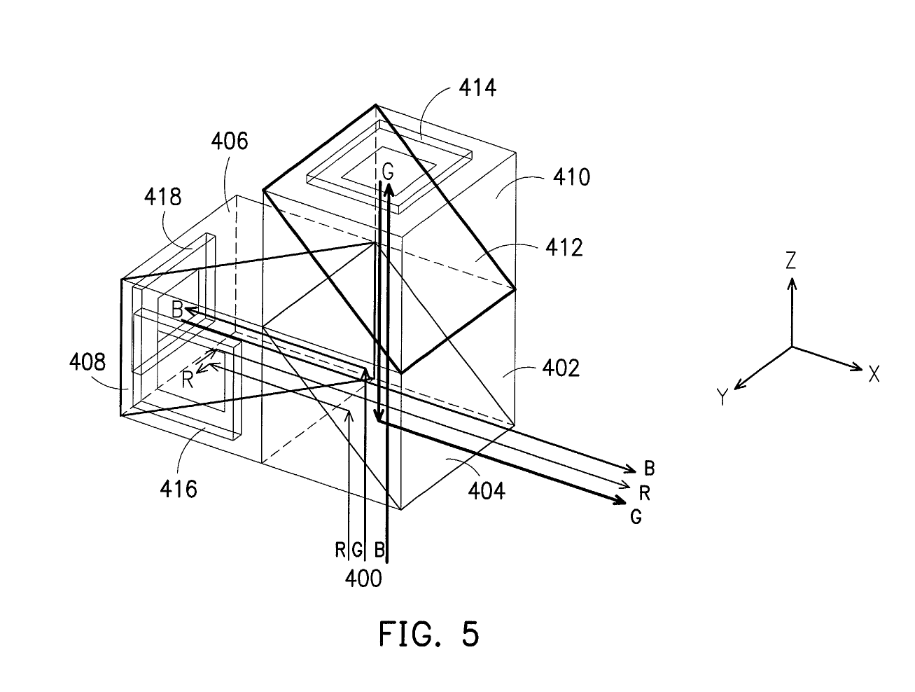

Referring to FIG. 5, a light source provides an incidence light 400. The incidence light 400 goes through the polarization beam splitter (PBS), and a light of Stype polarization is reflected from the PBS to the splitter component.

The splitter/recombiner component is a set of a dichroic cubes that includes a first dichroic cube, a second dichroic cube and a third dichroic cube. The first, second and third dichroic cubes have cubic structures. The first dichroic cube 402 includes a first coating 404 with a normal vector of (1,0,1). The incidence light 400 enters from the bottom of the first dichroic cube 402 and along the direction of (0,0,1) into the first dichroic cube 402. When the incidence light 400 enters the first coating 404, red light and blue light of the incidence light 400 are split by the first coating 404 and reflect along the direction of (−1,0,0) into the second dichroic cube 406lightcoating. The green light is transmitted through the first coating 404 and through the third dichroic cube 410 in the original direction along coordinates (0,0,1).

Red light and blue light of the incidence light 400 reflect from the first coating 404 along the direction of (−1,0,0). The second dichroic cube 406 is installed at the side of the first dichroic cube 402 in the optical path of the red light and blue light reflected from the first coating 404. The second dichroic cube 406 includes a second coating 408 with a normal vector of (1,1,0). Red light reflects from the first coating 404 along the direction of (0,1,0) and is projected from the second coating 408 to the red LCD panel 416. Blue light transmits through the second coating 408 to the blue LCD panel 418.

In the above described, green light travels along the direction of (0,0,1), blue light travels along the direction of (−1,0,0) and red light travels along the direction of (0,1,0). The optical paths of the three color lights are in a three dimensional format, not a planar two dimensional format, i.e., travelling along the same plane.

In the first dichroic cube 402, green light transmits through the first coating 404 in the original direction of the coordinates (0,0,1) into the third dichroic cube 410. The third dichroic cube 410 is installed over the first dichroic cube 402 in the transmission path of the green light. The third dichroic cube includes a third coating 412 with a normal vector having the same coordinates (1,0,1) as the normal vector of the first coating 404. Green light transmits through the third dichroic cube into the green LCD panel 414.

Green light can also reflect from the third coating 412 into the green LCD panel 414 in the third dichroic cube 410. The green LCD panel 414 must be installed in the optical path of the green light after it is reflected. The third dichroic cube can be replaced by a prism that has similar properties as the dichroic cube. Green light can transmit through the prism and reflect into the green LCD panel. Therefore, the size of the projector can be reduced.

Finally, a corresponding P-type polarization of green light, blue light and red light reflect into the projecting lens respectively from the green LCD panel 414, the blue LCD panel 416 and the red LCD panel 418, and an image is projected onto the screen.

The main characteristic of this invention is the three-dimensional format of the optical path, where the first coating and the second coating split the incidence light and the lights do not travel in the same plane. The size and area of the projector is reduced.

In this invention, the splitter component only includes two dichroic cubes and the projector uses less space than a conventional projector. A conventional projector, such as the Philips prism and color corner, has unused empty space over the projecting lens. In the present invention, the third dichroic cube is installed over the first dichroic cube. This design does not affect the operation of the components and makes use of the empty space over the projecting lens.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A structure of an optical path of a reflecting liquid crystal projector, comprising:
a light source, for entering light along a direction of (0,0,1);
a first dichroic cube, having a first coating with a normal vector of (1,0,1),
wherein the first coating transmits green light and reflects red light and blue light;
a second dichroic cube, installed at a side of the first dichroic cube where the red light and blue light are emitted from, the second dichroic cube having a second coating with a normal vector of (1,1,0), wherein the second coating transmits the blue light and reflects the red light;
a third dichroic cube, installed at a side of the first dichroic cube where the green light is emitted from;
a green liquid crystal display (LCD) panel, installed at a side of the third dichroic cube, for transmitting the green light;
a blue LCD panel, installed at a side of the second dichroic cube, for transmitting the blue light;
a red LCD panel, installed at another side of the second dichroic cube, for transmitting the red light;

2. The structure of claim 1, wherein the third dichroic cube comprises a third coating that allows the green light to transmit to the green LCD panel.

3. The structure of claim 1, wherein the third dichroic cube comprises a third coating that allows the green light to reflect to the green LCD panel.

4. The structure of claim 1, wherein the first, second and third dichroic cubes are cubic structures.

5. A structure of an optical path of a reflecting liquid crystal projector, comprising:
a light source that enters along a direction of (0,0,1), the light source comprising a first primary light, a second primary light and a third primary light;
a first dichroic cube having a first coating with a normal vector of (1,0,1),
wherein the first coating transmits the first primary light and reflects the second primary light and third primary light;
a second dichroic cube installed at a side of the first dichroic cube where the second and third primary lights are emitted from, the second dichroic cube having a second coating with a normal vector of (1,1,0), wherein the second coating transmits the second primary light and reflects the third primary light;
a third dichroic cube installed at a side of the first dichroic cube where the first primary light is emitted from;
a first primary light liquid crystal display (LCD) panel installed at a side of the third dichroic cube that transmits the first primary light;
a second primary light LCD panel installed at a side of the second dichroic cube that transmits the second primary light;
a third primary color LCD panel installed at a side of the second dichroic cube that transmits the third primary light;

6. The structure of claim 5, wherein the third dichroic cube comprises a third coating that allows the first primary light to transmit to the first primary light LCD panel.

7. The structure of claim 5, wherein the third dichroic cube comprises a third coating that allows the first primary light to reflect to the first primary light LCD panel.

8. The structure of claim 5, wherein the first, second and third dichroic cubes are cubic structures.
